(19) United States
(12) Patent Application Publication
(10) Pub. No.: US 2025/0069464 A1
(43) Pub. Date: Feb. 27, 2025

(54) DISPENSING DEVICE

(71) Applicant: SIGNIFI SOLUTIONS INC., Mississauga (CA)

(72) Inventors: Osten Xavier Conville, North York (CA); Richard Longo, Etobicoke (CA); Emil Jose Rodriguez Osorio, Etobicoke (CA); Yong Suk Jin, Oakville (CA); Shamira Jaffer, Mississauga (CA)

(21) Appl. No.: 18/620,615

(22) Filed: Mar. 28, 2024

Related U.S. Application Data
(60) Provisional application No. 63/578,482, filed on Aug. 24, 2023.

(51) Int. Cl. G07F 11/00

(52) U.S. Cl. CPC G07F 11/005

(57) ABSTRACT

An example device includes a hopper configured to store a plurality of items of a same type; a sorting assembly interconnected with the hopper and configured to extract a single item from the plurality of items, the sorting assembly comprising: a rotatable disk including at least one slot configured to receive the single item; a release aperture configured to allow the single item to be released from the sorting assembly when the disk is rotated to align the at least one slot with the release aperture; and a dispensing assembly configured to receive the single item from the sorting assembly and dispense the single item from the dispensing apparatus.

### CROSS-REFERENCE TO RELATED APPLICATION(S)

This application claims priority to U.S. Application No. 63/578,482 filed Aug. 24, 2023, entitled “SMALL ITEM DISPENSER”, the contents of which are incorporated herein by reference.

### FIELD

The specification relates generally to dispensing devices, and more particularly to dispensing devices for dispensing single items.

### BACKGROUND

Dispensing devices may be used to dispense items for users to retrieve and use upon request. When items are stored in bulk, it may be difficult to extract single items for high risk or high value items which may need to be tracked or otherwise managed.

### SUMMARY

According to an aspect of the present specification an example dispensing device comprising: a hopper configured to store a plurality of items of a same type; a sorting assembly interconnected with the hopper and configured to extract a single item from the plurality of items, the sorting assembly comprising: a rotatable disk including at least one slot configured to receive the single item; a release aperture configured to allow the single item to be released from the sorting assembly when the disk is rotated to align the at least one slot with the release aperture; and a dispensing assembly configured to receive the single item from the sorting assembly and dispense the single item from the dispensing apparatus.

According to another aspect of the present specification, an example method includes: receiving a dispensing request for an item; determining whether the item is ready to be dispensed from a holding area; when the item is ready to be dispensed, releasing the item from the holding area to an access landing area; and rotating a rotatable disk of a sorting assembly of the dispensing device according to a rotation profile until a further item is released from the sorting assembly to the holding area.

According to another aspect of the present specification, an example method includes: receiving a dispensing request for an item; rotating a rotatable disk of a sorting assembly of the dispensing device according to a rotation profile until the item is received in a slot of the rotatable disk; rotating the disk to align the slot with a release aperture of the sorting assembly to release the item to a dispensing assembly of the dispensing device; and dispensing the item from the dispensing assembly.

### BRIEF DESCRIPTION OF DRAWINGS

Implementations are described with reference to the following figures, in which:

FIG. 1 depicts a dispensing device in accordance with the present disclosure.

FIGS. 2A and 2B depict a perspective view and a side view, respectively, of an example rotatable disk in the dispensing device of FIG. 1.

FIG. 3 depicts an exploded view of an example sorting assembly in the dispensing device of FIG. 1.

FIG. 4 depicts a perspective view of an example sorting assembly in the dispensing device of FIG. 1.

FIG. 5 depicts the dispensing assembly of the dispensing device of FIG. 1.

FIG. 6 depicts a flowchart of an example method of dispensing an item in accordance with the present disclosure.

FIG. 7 depicts another example dispensing device in accordance with the present disclosure.

### DETAILED DESCRIPTION

Small items in the information technology (IT) industry may be difficult to manage, track and dispense. Besides software, there are many small items or accessories that are used in IT industry. Some of the most common ones are USB flash drives, external hard drives, headphones, microphones, webcams, laptop bags and cases, laptop cooling pads, and wireless mice and keyboards. These are just a few examples. There are many other small items and accessories that can be used in the IT industry depending on the specific needs of the user.

As authentication becomes important, small hardware security keys are offered to users as a solution for authentication. Security keys are physical devices that can be used as a second factor of authentication when logging into an account. They are used to protect against phishing attacks and are significantly more secure than SMS-based two-factor authentication. Security keys come in various formats, making them compatible with many devices you own.

The security keys may be substantially interchangeable, in that a user is able to use any given security key for authentication, provided that the security key dispensed to the user is previously identified and recorded. That is, a user may not simply select a security key from a bulk supply; rather the security key must be registered to the user. However, providing access to a multiple security keys is itself an insecure manner of distributing security keys.

Accordingly, in accordance with the present disclose, a dispensing device may dispense a single item (or a specified number of items, in accordance with the dispensing request). Further, in some examples, the dispensing device may automatically recognize and track an identifier for the single item to reduce risks and errors in the registration process.

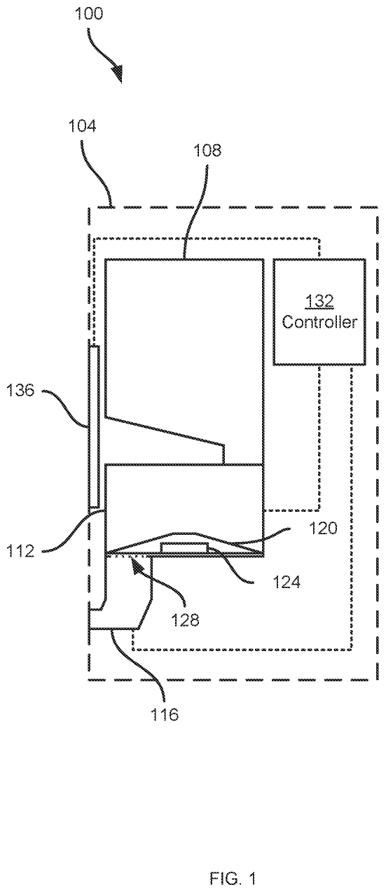

FIG. 1 depicts a dispensing device 100 in accordance with the present disclosure. The dispensing device 100 (also referred to herein as simply the device 100) is generally configured to store items and dispense single ones of the items to users. In particular, the items may be stored in bulk and may be substantially identical items having a same type. For example, the items may be information technology (IT) assets, such as security keys, fobs, universal serial bus (USB) sticks, Subscriber Identification Module (SIM) cards, near-field communication (NFC) tags, secure digital (SD) cards, and the like. The device 100 may be deployed in a hospital, warehouse, office building, or other facility to dispense items.

The device 100 includes an enclosure 104, a hopper 108, a sorting assembly 112, and a dispensing assembly 116.

The enclosure 104 is generally configured to house the internal components of the device 100 and secure the contents from unauthorized access. The enclosure 104 may include a frame, walls, plates, doors, and the like to define an interior of the device 100 in which the internal components are enclosed, and to provide suitable access. For example, the enclosure 104 may include one or more lockable doors which to restrict access to the interior of the device 100 to authorized operators. The enclosure 104 may also include, in some examples, wheels, motors, navigational units, batteries, and the like to support the operation and optional mobility of the device 100.

The hopper 108 is disposed in the enclosure 104 and is configured to store the plurality of items. In particular, the hopper 108 may store the items in bulk and feed the items to the sorting assembly 112. In particular, each of the items in the hopper 108 has the same type such that the hopper 108 stores items of a single type. For example, the hopper 108 may store a plurality of security keys, where each of the security keys has the same form (e.g., size and shape), function, and are substantially interchangeable with one another. In some examples, the hopper 108 may additionally include a lid (not shown), and one or more sensors (e.g., RFID/NFC sensors, optical sensors, cameras, weight sensors, etc.) to identify and detect a quantity of the items in the hopper 108.

The sorting assembly 112 is interconnected with the hopper 108 to receive the items from the hopper 108. The sorting assembly 112 is generally configured to extract a single one of the items from the plurality of items. In particular, the sorting assembly 112 includes a rotatable disk 120 including at least one slot 124. The at least one slot 124 is configured to receive the single item of the plurality of items for extraction by the sorting assembly 112. For example, the rotatable disk 120 may rotate back and forth and/or in a single direction to agitate the plurality of items in the sorting assembly 112 until the single item is received in the slot 124. The sorting assembly 112 may further include a motor (not shown) interconnected with the rotatable disk 120 to effect the rotation of the rotatable disk 120. For example, the motor may enable rotation of the disk 120 in a range from 0 to about 1000 rotations per minute (RPM), including different rotational directions and speeds.

The sorting assembly 112 further includes a release aperture 128 configured to release the single item from the sorting assembly 112. For example, upon receipt of the single item in the slot 124, the rotatable disk 120 may rotate to align the slot 124 with the release aperture 128 to release the single item from the sorting assembly 112. The sorting assembly 112 is described in further detail below.

The sorting assembly 112 is further interconnected with the dispensing assembly 116, which is configured to receive the single item (i.e., via the release aperture 128) and dispense the single item to a user. The dispensing assembly 116 is also described in greater detail below.

The device 100 may further include a controller 132 interconnected with the components of the device 100, and in particular, with the sorting assembly 112 and the dispensing assembly 116 to control the dispensing operation of the dispensing device 100. The controller 132 may include a processor, a central processing unit (CPU), a microcontroller, a microprocessor, a processing core, a field-programmable gate array (FPGA), or similar. The controller 132 may include multiple cooperating processors. The controller 132 may cooperate with a memory, including a combination of volatile (e.g., random access memory or RAM) and non-volatile memory (e.g., read-only memory or ROM, electrically erasable programmable read-only memory or EEPROM, flash memory) to realize the functionality described herein. All or some of the memory may be integrated with the controller 132.

The memory may store applications, each including a plurality of computer-readable instructions executable by the controller 132; execution of the instructions configures the device 100 and/or the controller 132 to perform the actions discussed herein. The application may be implemented as a suite of distinct applications, and some or all of the functionality of the application may be implemented as dedicated hardware components, such as one or more FPGAs or application-specific integrated circuits (ASICs).

Generally, the controller 132 is configured to manage the dispensing operation of the device 100, as will be described further herein. For example, the controller 132 may receive a dispensing request via a user interface 136 of the device 100. In particular, the controller 132 may control the disk 120 of the sorting assembly 112 to rotate to align the slot 124 with the release aperture 128 to release the single item via the dispensing assembly 116. The controller 132 may subsequently control further rotation of the disk 120 (e.g., back and forth to agitate the plurality of items) to receive another single item in the slot 124 for a subsequent dispensing operation.

In another example, in accordance with a reactive dispensing operation, upon receiving a dispensing request via the user interface 136, the controller 132 may control the disk 120 to rotate (e.g., according to a rotation profile), which may include back and forth rotation to agitate the plurality of items until a single item is received in the slot 124 and released via the release aperture 128. That is, rotation of the disk 120 to agitate the items to receive a single item in the slot 124 may occur in response to the dispensing request, rather than after dispensing an item.

The user interface 136 may include a display, a touch screen, a payment device, an identification device, a keypad, a camera, and the like. For example, the user interface 136 may include both input and output devices. Additionally, the user interface 136 may include non-contact assistive devices, including one or more cameras, speakers, microphones, and the like for gesture or voice recognition.

In some examples, the device 100 may further include a communications interface (not shown), which may be configured for wireless (e.g., satellite, radio frequency, Bluetooth, Wi-Fi, or other suitable communications protocols) or wired communications and may include suitable hardware (e.g., transmitters, receivers, network interface controllers, and the like) to allow the device 100 to communicate with other computing devices. The specific components of the communications interface are selected based on the types of communication links that the device 100 communicates over.

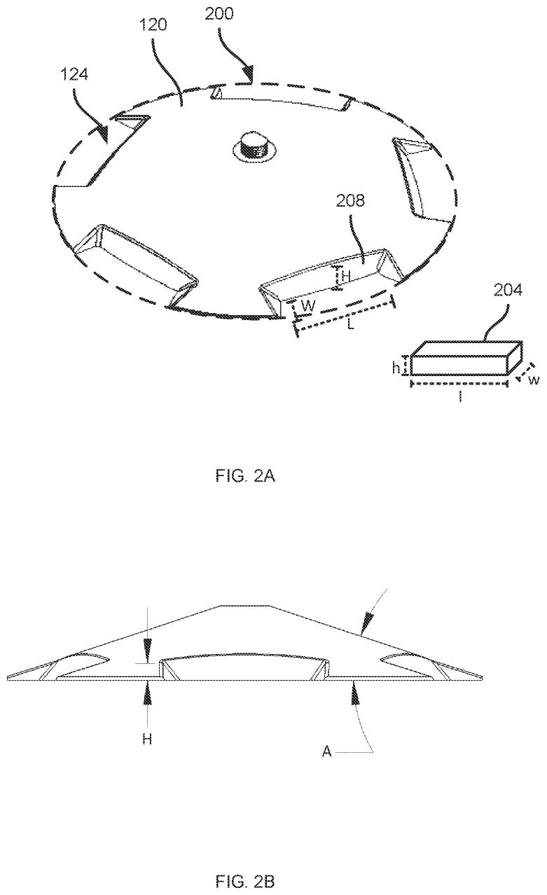

Turning now to FIGS. 2A and 2B, example a perspective view and a side view of the disk 120 are depicted. In particular, the disk 120 may preferably include a plurality of slots 124 extending from a circumference 200 of the disk 120. The slots 124 may be sized based on the type of the item to be extracted by the disk 120. For example, the slots 124 may be sized based on a first type of an item 204 to accommodate a single one of the items 204.

For example, a length L of the slots 124 may be measured as a chord between the two points on the circumference 200 from which the slot 124 extends. The length L of the slots 124 may correspond to a longest dimension I of the item 204. For example, the length L of the slots 124 may be about 5-10% longer than the longest dimension I of the item 204. In other examples, the length L may correlate with the longest dimension I according to a predefined buffer length (e.g., about 1 mm or about 3 mm, etc.), or other suitable correlation.

Similarly, a width W of the slots 124 may correspond to an intermediate dimension w of the item 204. For example, the width W of the slots 124 may be about 5-10% longer than the intermediate dimension w of the item 204. In other examples, the width W may correlate with the intermediate dimension w according to a predefined buffer length (e.g., about 1 mm or about 3 mm, etc.), or other suitable correlation. In the present example, the width W may be measured from the two points on the circumference 200 from which the slot 124 extends, substantially perpendicular to the chord between said two points (i.e., substantially perpendicular to the length L of the slots 124). Thus, the item 204 may be contained substantially entirely within the circumference 200 of the disk 120 when the item 204 is received in the slot 124. In other examples, the width W may be measured at a midpoint of the length L, radially, such that portions of the item 204 (e.g., corners of the item 204) may extend past the circumference 200 of the disk 120.

A height H of the slots 124 may correspond to a shortest dimension h of the item 204. For example, the height H of the slots 124 may be about 5-10% longer than the shortest dimension h of the item 204. In other examples, the height H may correlate with the shortest dimension h according to a predefined buffer length (e.g., about 1 mm or about 3 mm, etc.), or other suitable correlation. The height H of the slots 124 may be measured as a thickness of the disk 120. In some examples, the disk 120 may be angled at an angle A (depicted in FIG. 2B) from the circumference 208-1 to a center of the disk 120; that is, the disk 120 may have a substantially conical profile. Accordingly, the height H may be measured at an inner wall 208 of the slot 124, for example at a midpoint of the length L. In some examples, the angle A of the disk 120 may be defined such that the target height H corresponding to the shortest dimension h is achieved when the item 204 is received in the slot 124.

In further examples, the angle A of the disk 120 may be defined to be within a predefined range, and accordingly, if the target height H causes the angle A to exceed the predefined range, a radius of the disk 120 may be adjusted to allow the angle A to be within the predefined range while achieving the target height H.

The disk 120 may further include angled or slanted walls, including the inner wall 208, defining each of the slots 124, for example to facilitate direction of the item 204 into the slot 124. Further, the edges between a top surface of the disk 120 and the walls, including the inner wall 208, may be chamfered to further facilitate movement and receipt of the item 204 in the slot 124.

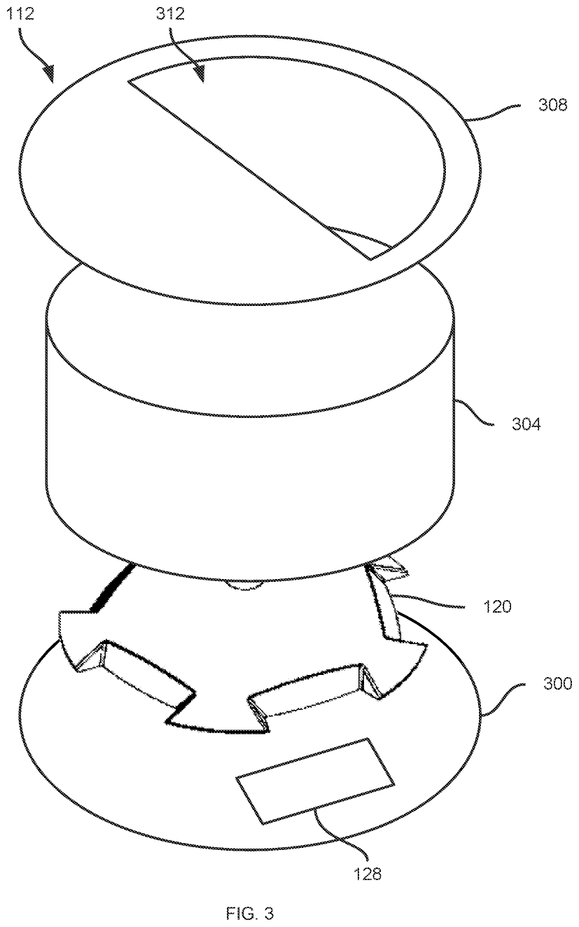

Turning now to FIG. 3, an exploded view of the sorting assembly 112 is depicted. The sorting assembly 112 may include a base plate 300 in which the release aperture 128 is situated. The base plate 300 may support the disk 120. Further, the sorting assembly 112 may include an outer wall 304 enclosing the sorting assembly 112. In particular, the wall 304 may extend substantially around the disk 120 and may enclose an interior of the sorting assembly 112 into which the items are deposited from the hopper 108. The wall 304 may further serve to maintain the items within the sorting assembly on the disk 120 to allow a single one of the items to be received in one of the slots 124. The sorting assembly 112 may further include a top plate 308 having an inlet 312 to receive the items from the hopper 108.

Thus, in operation, the sorting assembly 112 may receive the items from the hopper 108 via the inlet 312. The items may be maintained over the disk 120 via the wall 304. The controller 132 may control the disk 120 to rotate, thereby agitating the items. For example, if an item is partially lodged in one of the slots 124 (e.g., in a non-complementary orientation), a majority of the item may extend from the slot 124 and hence the rotation of the disk 120 may cause the item to be dislodged and may therefore agitate nearby items. The controller 132 may be configured to store a rotation profile for the disk 120 according to the type of the item, as affected by size, shape, weight, and other physical characteristics of the item, for example. For example, an optimal rotation profile may be experimentally determined for each type of item.

For example, the rotation profile may include a direction of rotation, a time period for rotation, an acceleration rate of rotation, a target speed of rotation, a series of rotations, and the like. For example, the rotation profile may include an alternating series of clockwise and counterclockwise rotations. Alternately, the rotation profile may include a single direction of rotation at differing speeds and/or rates of acceleration.

One example rotation profile may include: (i) rotating the disk 120 clockwise for 1 second, with an acceleration rate of 50 mm/s² and a target speed of 20 mm/s; (ii) rotating the disk 120 counter-clockwise for 1 second, with an acceleration rate of 50 mm/s² and a target speed of 20 mm/s; (iii) rotating the disk 120 clockwise for 4 seconds, with an acceleration rate of 20 mm/s² and a target speed of 40 mm/s; and (iv) returning to (i) as needed. The rotation profile may additionally include a stop condition, including a timeout period, detection of receipt of a single item in the slot 124 in a complementary and/or target orientation (as will be described further below), detection of passage of a single item through the release aperture 128, or the like.

According to another example, the rotation profile may include: (i) rotating counter-clockwise with a radial displacement of approximately 4 slot-lengths for 3 seconds; (ii) rotating clockwise with a radial displacement of approximately 1 slot-length for 1 second; (iii) rotating counter-clockwise with a radial displacement of approximately 2 slot-lengths for 2 seconds; and (iv) rotating clockwise with a radial displacement of approximately 0.5 slot-lengths for 1 second. The rotation profile may include a similar stop condition, including a timeout period, detection of receipt of a single item in the slot 124 in a complementary and/or target orientation, detection of passage of a single item through the release aperture 128, or the like.

In some examples, the rotation profile may serve to both align the slot 124 with the release aperture 128 to allow a single item to be released from the sorting assembly 112, as well as to agitate the items to allow a single one of the items to be received in the slot 124 for a subsequent dispensing operation. In other examples, the sorting assembly 112 may further include a blocking plate (not shown) configured to cover the release aperture 128 during rotation of the disk 120 to agitate the items for receipt of one of the items in the slot 124 without causing release of the item in the slot 124. The blocking plate may be rotatable, hinged, slidable, or the like to move to block or unblock the release aperture 128.

When an item is received in one of the slots 124 in a complementary orientation, i.e., such that the dimensions of the item correspond with the dimensions of the slot (i.e., the item is oriented in the slot 124 such that the longest dimension extends along the length L of the slot 124 and the shortest dimension extends along the height H of the slot 124), then the item may be complementary to the profile of the disk 120. That is, the item may substantially fit with the profile of the disk 120, and hence rotation of the disk 120 may be less likely to cause further disturbance and removal of the item from the slot 124. In some examples, the sorting assembly 112 may include one or more sensors (e.g., optical sensors, electromagnetic sensors, weight-based sensors, combinations of the above, and the like) configured to detect receipt of one of the items in the complementary orientation within the slot 124.

In other examples, other components of the sorting assembly 112 may also include features to facilitate agitation of the items in the sorting assembly 112 for receipt of an item in the complementary orientation in the disk 120. For example, a top surface of the disk 120 or the interior of the wall 304 may include extensions or protrusions to block or partially restrict movement of some of the items when the disk 120 to further agitate the items. The sorting assembly 112 may further include anti-static features, such as ground wirings and/or anti-static materials to reduce static effects and/or damage to the items in the sorting assembly 112 due to the rotational motion of the disk 120.

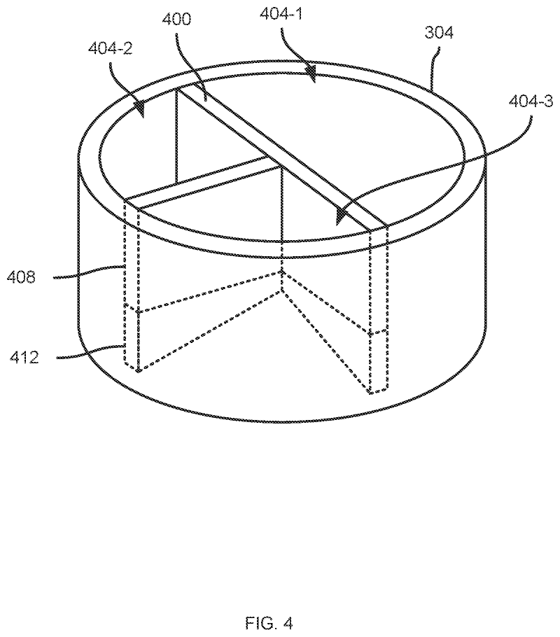

For example, turning now to FIG. 4, the sorting assembly 112, and in particular, the interior of the sorting assembly as defined by the wall 304, may further include one or more dividers 400 configured to partition the interior of the sorting assembly 112 into at least two sectors, and in the present example, three sectors 404-1, 404-2, and 404-3 (referred to herein generically as a sector 404 and collectively as the sectors 404; this nomenclature may also be used elsewhere herein).

In the present example, the first sector 404-1 is aligned with the inlet 312 of the sorting assembly 112 and is generally configured to accumulate the items in the sorting assembly 112 as received from the hopper 108. That is, the hopper 108 may feed the items into the first sector 404-1. Further, upon rotation of the disk 120, the dividers 400 may block or substantially restrict movement of the items to maintain a majority of the items in the first sector 404-1.

In some examples, the dividers 400 may include a fixed or rigid portion 408 and a flexible portion 412. The flexible portion 412 may be adjustable relative to the fixed portion 408 according to a size of the items. For example, the flexible portion 412 may be height-adjustable to be positioned closer to or further from the disk 120. Further, the flexible portion 412 may be somewhat flexible and may be formed of rubber or the like to allow some deformation of the flexible portion 412, for example to allow a small number of the items to move past the dividers 400, for example if they are partially lodged in the slot 124 and rotation of the disk 120 drives the items past the flexible portion 412 of the dividers 400.

Accordingly, the second sector 404-2 may be configured to receive a subset of the items, for example based on a number of items compelled past the dividers 400 due to rotation of the disk 120. Since the dividers 400 may maintain the majority of the items in the sorting assembly 112 in the first sector 404-1, the second sector 404-2 may have a small or limited number of items. Accordingly, rotation of the disk 120 to agitate the items in the second sector 404 may cause greater movement of the items, since the items are able to move more freely without being restricted or obstructed by the majority of the items (e.g., including the weight of the majority of the items). Accordingly, rotation of the disk 120 may cause better agitation of the items to more likely induce receipt of one of the items in the complementary orientation in the slot 124.

The third sector 404-3 may be aligned with the release aperture 128 for release of the single item from the sorting assembly 112. Accordingly, the divider 400 between the second sector 404-2 and the third sector 404-3 may maintain any additional items in the second sector 404-2 to ensure that only the single item is released to the release aperture 128 in the third sector 404-3.

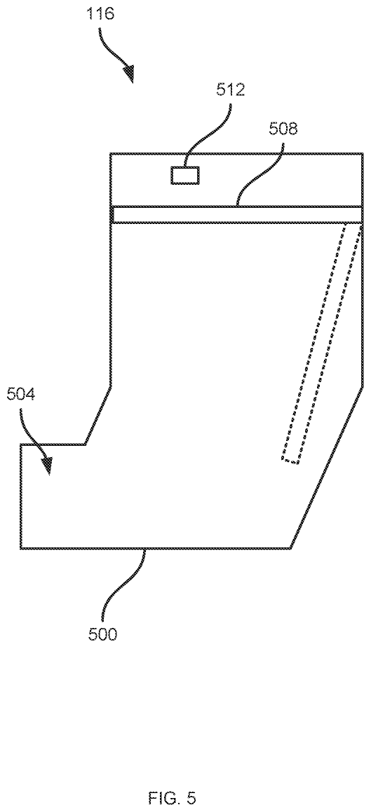

Turning now to FIG. 5, the dispensing assembly 116 is depicted in greater detail. In particular, the dispensing assembly 116 includes a chute 500 terminating in an access landing area 504. The dispensing assembly 116 further includes a controllable flap 508 and a sensor 512.

The chute 500 is generally configured to direct the single item received in the dispensing assembly 116 via the release aperture 128 and direct the single item to an access aperture of the device 100. In particular, the access aperture may be an opening or a door in the enclosure 104 or similar, with access to the access landing area 504, which may be a substantially flat (i.e., horizontal with the ground or a support surface) portion of the chute 500 to catch the single item. That is, the single item is configured to terminate at the access landing area 504 to allow a user to retrieve the item via the access aperture. In some examples, the access landing area 504 may include features to facilitate the catching of the single item from the chute 500.

The flap 508 may be a panel or the like, configured to move between a closed position, in which the flap 508 blocks the chute 500, and an open position, in which the flap 508 unblocks the chute 500. That is, the flap 508 may be interconnected with the controller 132 to control movement of the flap 508. In particular, the flap 508 may remain in the closed position until a dispensing request is received, and the single item is received at the dispensing assembly 116. That is, the single item may be received at the dispensing assembly 116 and maintained on the flap 508.

Accordingly, the sensor 512 may be disposed within the chute 500 and configured to detect the single item on the flap 508. For example, the sensor 512 may be an optical sensor, an electromagnetic sensor, a radio-frequency identification (RFID) sensor, a weight sensor integrated with the flap 508, a suite of sensors, combinations of the above, and the like. The sensor 512 may similarly be interconnected with the controller 132 to allow the sensor 512 to communicate detected signals to the controller 132. In other examples, the sensor 512 may additionally or alternately be configured to monitor receipt or passage of the single item through the release aperture 128 rather than when it is caught by the flap 508. For example, the sensor 512 may have an integrated functionality to monitor both detections, or the device 100 may include separate sensors 512 to monitor the flap 508 and the release aperture 128.

Thus, in operation, the controller 132 may maintain the flap 508 in the closed position to act as a holding area. The controller 132 may periodically poll the sensor 512 and/or the sensor 512 may be configured to periodically send signals to the controller 132 and/or the sensor 512 may be configured to send a signal to the controller 132 upon detection of the single item on the flap 508. In some examples, the device 100 may be configured to extract the single item to be stored on the flap 508 in preparation for a dispensing request. That is, the single item may be maintained in the holding area on the flap 508 until a dispensing request is received. In other examples, the device 100 may be configured to extract the single item to the flap 508 in response to the dispensing request. That is, detection of the single item on the flap 508 may be performed as a verification that the dispensing operation was properly completed to dispense the single item to the user.

In response to detecting, at the sensor 512, the single item on the flap 508 and receipt of the dispensing request, the controller 132 may release the flap 508 to the open position to allow the single item to proceed through the chute 500 to the access landing area 504 to be retrieved by a user.

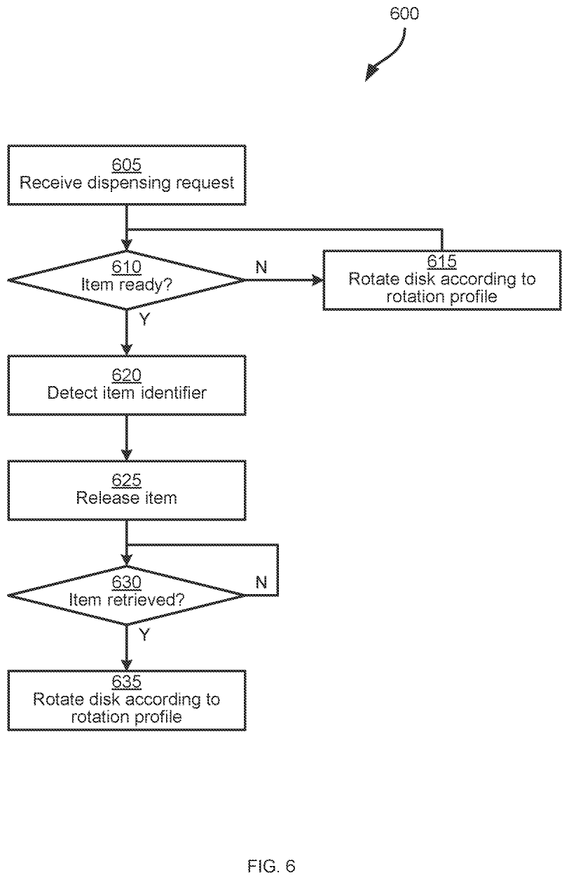

Turning now to FIG. 6, the functionality implemented by the device 100 will be discussed in greater detail. FIG. 6 illustrates a method 600 of dispensing an item. The method 600 will be discussed in conjunction with its performance in the device 100, for example via execution of instructions by the controller 132. In particular, the method 600 will be described with reference to the components of FIGS. 1 to 5. In other examples, the method 600 may be performed by other suitable devices and/or systems.

At block 605, the device 100 receives a dispensing request, for example via the user interface 136. In particular, the dispensing request may be for one of the items. For example, the item may be a security key or the like, and accordingly, a user may request a one-time use security key to access a computing device within a network infrastructure. That is, the dispensing request may be for a single one of the type of item, rather than a particular item itself; each of the items may be substantially identical, both in form and in function.

In some examples, the device 100 may additionally perform one or more security verification or authentication processes, for example to verify that the dispensing request originated from an authorized user. Alternately, the device 100 may simply perform a user identification (e.g., facial or voice recognition, receipt of user input representing a user identifier such as a name, email, identification number, or the like) to track an association between the user and the subsequently dispensed item.

At block 610, in response to the dispensing request, the device 100 determines whether the item is ready to be dispensed. For example, the controller 132 may poll the sensor 512 to determine whether an item is detected on the flap 508. In other examples, rather than detecting the item on the flap 508, the sensor 512 may detect movement and/or passage of the item through the chute 500 and/or the dispensing assembly 116.

If the determination at block 610 is negative, that is, the item is not ready to be dispensed, then the device 100 proceeds to block 615. At block 615, the device 100, and in particular the controller 132, rotates the disk 120 according to a rotation profile, for example stored in the memory associated with the controller 132. For example, the rotation profile may simply include rotating the disk 120 to align an adjacent slot 124 with the release aperture 128. In other examples, the rotation profile may include sufficient rotation to agitate the items in the sorting assembly 112 to facilitate receipt of a single one of the items in one of the slots 124.

After rotating the disk according to the rotation profile, the device 100 may return to block 610 to determine if the item is ready to be dispensed.

If the determination at block 610 is affirmative, that is, the item is ready to be dispensed, then the device 100 proceeds to block 620. At block 620, the device 100 may optionally detect an item identifier for the item ready to be dispensed. For example, the sensor 512 may detect an item identifier for the item on the flap 508, via RFID, optical detection (e.g., of a barcode or quick-response (QR) code, or using image analysis/object detection), or the like. The device 100 may then store an association between the dispensing request received at block 605 (i.e., including any obtained user-identifying information associated with the dispensing request) and the item identifier information obtained at block 620.

At block 625, the device 100 is configured to release the single item. For example, when the item is being maintained on the flap 508, the controller 132 may be configured to release the flap 508 to allow the item to be released to the access landing area 504 of the chute 500, from which the user may retrieve the item. In some examples, in response to releasing the item, the device 100 may issue a release notification, such as a visual and/or auditory notification or the like, that the item has been released for retrieval by the user. For example, the device 100 may include an LED light module which may blink or otherwise change color when the item is ready to be retrieved. In some examples, the device 100 may further include a controlled gate or door to control access to the landing area 504 and/or to prevent the item from tumbling past the landing area 504. In such examples, upon release of the item by the flap 508, the controller 132 may additionally unlock the gate or door.

At block 630, the device 100 may optionally determine whether the item has been retrieved and/or successfully dispensed. For example, the dispensing assembly 116 may include an additional sensor to monitor the access landing area 504 to determine whether the dispensed item has been retrieved by the user. In some examples, after a predefined timeout period, the device 100 may issue a reminder notification, such as a visual and/or auditory notification or the like, that the item is ready for retrieval by the user. In some examples, after a further predefined period, the device 100 may determine an error condition and send an error notification to a managing operator of the device 100. The error notification may be an email, a text message, or the like.

If the determination at block 630 is affirmative, that is, the item has been retrieved, then the device 100 may proceed to block 635. At block 635, the device 100, and in particular, the controller 132, may rotate the disk 120 according to the rotation profile, for example to prepare for a subsequent dispensing operation. For example, the controller 132 may rotate the disk 120 according to the rotation profile until a single item is released from the sorting assembly 112 via the release aperture 128 and received on the flap 508.

In some examples, the dispensing request may specify a particular number of the items to be dispensed, rather than a single one of the items. In such examples, the determination at block 610 may be whether the requested number of items are ready to be dispensed. As will be appreciated, since the sorting assembly releases a single one of the items, the device 100 may iterate through blocks 610 and 615 until the requested number of items is reached. That is, the rotatable disk 120 may be rotated according to the rotation profile to dispense one item from one of the slots 124 at a time to the holding area on the flap 508 until the requested number of items are in the holding area.

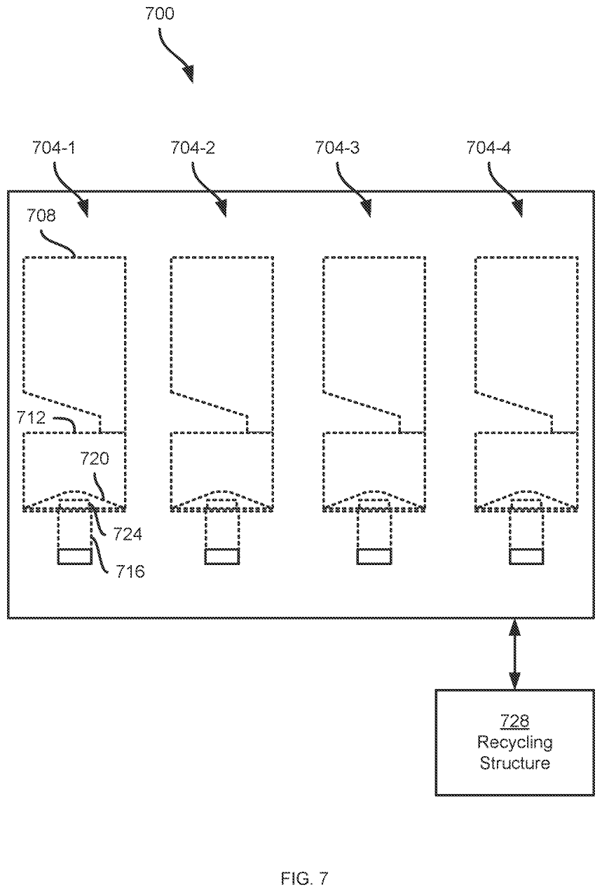

Turning now to FIG. 7, another example dispensing device 700 is depicted. The dispensing device 700 is configured to store items and dispense single ones of those items to users. In particular, the dispensing device 700 includes multiple dispensing subsystems 704-1, 704-2, 704-3, and 704-4, each having a respective hopper 708, sorting assembly 712, and dispensing assembly 716. Accordingly, the dispensing device 700 may dispense multiple types of items, wherein one type of item is dispensed by one of the dispensing subsystems 704.

Each rotatable disk 720 of the respective sorting assembly 712 may have respective slots 724 sized according to the type of item to be dispensed by the respective dispensing subsystem 704.

The dispensing device 700 may further include one or more user interfaces to allow a user to select a type of item to be dispensed and/or other particulars regarding the dispensing operation, including notification modules (e.g., LED light modules, screens, speakers, etc.), identification modules and the like. Further the hoppers 708 may have lids to prevent cross-contamination of items between the hoppers 708. The lids and/or access to the interior of the dispensing device 700 may be controlled by doors and electronic strikes and/or latches, or other locking devices.

As illustrated herein, the dispensing device 700 may additionally be coupled with a recycling structure 728 (e.g., integrated into the enclosure of the dispensing device 700 or separate from the dispensing device 700) which may accept used and/or broken items. The recycling structure 728 may be integrated with the controller of the dispensing device 700, for example for communications with a central server and to facilitate identification and tracking of items deposited to the recycling structure 728.

Accordingly, as described herein, a dispensing device provides a sorting assembly for extracting single items including items having different and/or irregular shapes, sizes and other physical structures, such as IT assets or security keys. The sorting assembly uses a rotatable disk with slots corresponding to the type of item to be extracted by the sorting assembly. The dispensing device may use a rotating profile tuned to the type of the item to rotate the disk to agitate the bulk of items to facilitate receipt of a single item in the slot in a complementary orientation to the slot. The dispensing device may then be enabled to control the release of the single item, including identifying the single item and storing an association with a user's dispensing request for automatic management and tracking of the items.

The scope of the claims should not be limited by the embodiments set forth in the above examples but should be given the broadest interpretation consistent with the description as a whole.

1. A dispensing device comprising:
a hopper configured to store a plurality of items of a same type;
a sorting assembly interconnected with the hopper and configured to extract a single item from the plurality of items, the sorting assembly comprising:
a rotatable disk including at least one slot configured to receive the single item;
a release aperture configured to allow the single item to be released from the sorting assembly when the disk is rotated to align the at least one slot with the release aperture; and
a dispensing assembly configured to receive the single item from the sorting assembly and dispense the single item from the dispensing device.

2. The dispensing device of claim 1, wherein the at least one slot is sized based on the type of the item to accommodate the single item.

3. The dispensing device of claim 1, wherein the at least one slot extends from a circumference of the rotatable disk.

4. The dispensing device of claim 3, wherein:
a length of the at least one slot corresponds to a longest dimension of the single item;
a width of the at least one slot corresponds to an intermediate dimension of the single item; and
a height of the at least one slot corresponds to a smallest dimension of the single item.

5. The dispensing device of claim 4, wherein the rotatable disk is angled from a center of the disk to the circumference of the disk; and wherein the height of the slot is measured at an inner wall of the slot.

6. The dispensing device of claim 1, wherein the sorting assembly comprises:
a first divider defining a first sector configured to receive the plurality of items from the hopper; and
an additional divider defining (i) a second sector configured to receive a subset of the plurality of items and (ii) a third sector aligned with the release aperture.

7. The dispensing device of claim 6, wherein the first divider comprises a rigid portion and a flexible portion configured to deform to allow the subset of the plurality of items to the second sector.

8. The dispensing device of claim 1, wherein the dispensing assembly comprises:
a chute configured to receive the single item from the sorting assembly via the release aperture; and
an access landing area configured to catch the single item to dispense the single item.

9. The dispensing device of claim 8, wherein the chute further includes:
a controllable flap configured to maintain the single item in the chute, wherein the controllable flap is configured to be released to dispense the single item in response to a dispensing request.

10. The dispensing device of claim 9, wherein the chute further includes:
a sensor configured to detect the single item on the controllable flap.

11. The dispensing device of claim 1, wherein the dispensing assembly comprises:
a sensor configured to detect passage of the single item through the release aperture.

12. A method in a dispensing device, the method comprising:
receiving a dispensing request for an item;
determining whether the item is ready to be dispensed from a holding area;
when the item is ready to be dispensed, releasing the item from the holding area to an access landing area; and
rotating a rotatable disk of a sorting assembly of the dispensing device according to a rotation profile until a further item is released from the sorting assembly to the holding area.

13. The method of claim 12, wherein rotating the rotatable disk of the sorting assembly further comprises agitating a plurality of items in the sorting assembly to receive the item in a slot of the rotatable disk.

14. The method of claim 12, wherein releasing the item from the holding area comprises releasing a flap configured to maintain the item in the holding area.

15. The method of claim 12, further comprising detecting an item identifier of the item in the holding area and associating the item identifier with the dispensing request.

16. The method of claim 12, further comprising:
when the dispensing request specifies a requested number of the item, rotating the rotatable disk according to the rotation profile to dispense one item to the holding area until the requested number of items are in the holding area.

17. The method of claim 12, further comprising:
when the item is not ready to be dispensed from the holding area, rotating the rotatable disk according to the rotation profile until the item is released from the sorting assembly to the holding area.

18. A method in a dispensing device, the method comprising:
receiving a dispensing request for an item;
rotating a rotatable disk of a sorting assembly of the dispensing device according to a rotation profile until the item is received in a slot of the rotatable disk;
rotating the disk to align the slot with a release aperture of the sorting assembly to release the item to a dispensing assembly of the dispensing device; and
dispensing the item from the dispensing assembly.

19. The method of claim 18, wherein dispensing the item from the dispensing assembly comprises:
catching the item on a flap; and
releasing the flap to dispense the item.

20. The method of claim 19, further comprising: after catching the item and prior to releasing the flap, identifying the item and associating the item with the dispensing request.
